(19) United States
(12) Patent Application Publication
(10) Pub. No.: US 2017/0129387 A1
(43) Pub. Date: May 11, 2017

(54) REPLACEMENT VEHICLE LAMP ASSEMBLY WITH ATTACHMENT MEMBER

(71) Applicants: Michael Speranza, Erie, PA (US); Scott Troutman, Falconer, NY (US)

(72) Inventors: Michael Speranza, Erie, PA (US); Scott Troutman, Falconer, NY (US)

(73) Assignee: Truck-Lite Co., LLC, Falconer, NY (US)

(21) Appl. No.: 15/343,331

(22) Filed: Nov. 4, 2016

Related U.S. Application Data
(60) Provisional application No. 62/252,348, filed on Nov. 6, 2015.

(51) Int. Cl. B60Q 1/00; B60Q 1/26

(52) U.S. Cl. CPC B60Q 1/0064; B60Q 1/2696; B60Q 1/2615

(57) ABSTRACT

A replacement lamp assembly for replacing a vehicle lamp that has been broken out leaving at least one cylindrical lamp flange is provided. The replacement lamp assembly includes a vehicle lamp having a housing with a base, a lens and an interior portion with at least one light source positioned therein and an attachment member. The attachment member includes an upper lamp retaining section having a first cylindrical wall with an inner surface and an outer surface, a second cylindrical wall with an inner surface and an outer surface spaced apart from the first cylindrical wall and connected thereto by an upper edge, wherein a lower end of second cylindrical wall abuts the at least one flange. A mounting section is formed integral with the lamp retaining section and includes a third cylindrical wall with an inner surface and an outer surface. The outer surface includes a plurality of angled projections extending outward therefrom in a direction towards the lamp retaining section for engaging irregular edges of the at least one flange.

### BRIEF DESCRIPTION OF THE DRAWINGS

FIG. 1A is a perspective view of an attachment member according to one embodiment of a replacement vehicle lamp assembly.

FIG. 1B is a perspective view of a replacement vehicle lamp assembly including the attachment member of FIG. 1A.

FIGS. 1C and 1D are cross-sectional views of the attachment member of FIGS. 1A and 1B.

FIG. 2A is a perspective view of an attachment member according to an alternate embodiment of a replacement vehicle lamp assembly.

FIG. 2B is a perspective view of a replacement vehicle lamp assembly including the attachment member of FIG. 2A.

FIG. 2C is a cross-sectional view of the attachment member of FIGS. 2A and 2B.

FIG. 3A is a perspective view of an attachment member according to a further embodiment of a replacement vehicle lamp assembly.

FIG. 3B is a perspective view of a replacement vehicle lamp assembly including the attachment member of FIG. 3A.

FIG. 3C is a cross-sectional view of the attachment member of FIGS. 3A and 3B.

FIG. 4 shows a perspective view of a replacement vehicle lamp assembly according to another embodiment.

FIG. 5 shows a perspective view of a back side of a mounting surface.

FIG. 6 shows a perspective view of a front side of a mounting surface.

FIG. 7 is a cross-sectional view of a replacement lamp assembly mounted within a flange.

### BRIEF SUMMARY OF THE INVENTION

A replacement lamp assembly for replacing a vehicle lamp that has been broken out leaving at least one cylindrical lamp flange with an opening having a diameter, hereinafter referred to as the mounting opening diameter, is provided. The replacement lamp assembly includes a vehicle lamp having a housing with a base, a lens and an interior portion with at least one light source positioned therein and an attachment member. The attachment member includes an upper lamp retaining section having a first cylindrical wall with an inner surface and an outer surface, a second cylindrical wall with an inner surface and an outer surface spaced apart from the first cylindrical wall and connected thereto by an upper edge, wherein a lower end of second cylindrical wall abuts the at least one flange. The inner surface of the first cylindrical wall defines an aperture with a first diameter and the outer surface of the first cylindrical wall defines a cylinder with a second diameter that is larger than the mounting opening diameter. The inner surface includes grooves formed therein for engaging and securing the lamp housing.

A mounting section is formed integral with the lamp retaining section and includes a third cylindrical wall with an inner surface and an outer surface. The inner surface of the third cylindrical wall defines an aperture with a third diameter, which is smaller than the first diameter, i.e. the diameter of the aperture defined by the inner surface of the first cylindrical wall, and the second diameter, i.e. the diameter of the cylinder defined by the outer surface of the first cylindrical wall. The outer surface of the second cylindrical wall further includes a plurality of angled projections extending outward therefrom in a direction towards the lamp retaining section for engaging irregular edges of the at least one flange.

### DETAILED DESCRIPTION OF THE EMBODIMENTS

For the purpose of promoting an understanding of the embodiments disclosed herein, references are made in the text hereof to embodiments of replacement vehicle lamp assemblies, only some of which are illustrated in the drawings. It is nevertheless understood that no limitations to the scope of the invention are thereby intended. One of ordinary skill in the art will readily appreciate that modifications such as the shape and materials of the components, the positioning of the components, the color of the lamps or lenses, and the number of vehicle lamps do not depart from the spirit and scope of the present invention. Some of these possible modifications are mentioned in the following description. Furthermore, in the embodiments depicted, like reference numerals refer to identical structural elements in the various drawings.

The replacement lamp assemblies described herein are typically clearance, marker, or identification lamps. A “clearance lamp” is a lamp “mounted on the permanent structure of the vehicle as near as practicable to the upper left and right extreme edges that provide light to the front or rear to indicate the overall width and height of the vehicle.” A “side marker lamp” is a lamp that is “mounted on the permanent structure of the vehicle as near as practicable to the front and rear edges, which provide light to the side to indicate the overall length of the vehicle.” Further, “combination clearance and side marker lamps” are defined as “single lamps which simultaneously fulfill performance requirements of clearance and side marker lamps” and “identification lamps” are defined as “lamps used in groups of three, in a horizontal row, that provide light to the front or rear or both, having lamp centers that are spaced not less than 150 mm nor more than 310 mm apart, mounted on the permanent structure as near as practicable to the vertical centerline and the top of the vehicle to identify vehicles 2032 mm or more in overall width.” Unless otherwise noted, the Society of Automotive Engineers (SAE) definitions of these terms are adopted and used herein. The lamp assemblies described in the instant application are intended to be used in any or all of these applications. The various embodiments discussed infra will satisfy all SAE standards for photometric requirements as well as chromaticity.

Vehicle lights according to the embodiments of the invention may be flanged or non-flanged lamps that may be further fitted with security flanges. In general, vehicle lamps and security flanges are attached to an opening in a vehicle surface by riveting. In accordance with embodiments disclosed herein, a vehicle lamp with a plastic flange is mounted in a drilled hole or opening extending through an exterior surface of a vehicle body wall. The flange may contain a plurality of holes for receiving fasteners for fixedly securing the lamp to the vehicle. A security flange, which may be made of stainless steel, is installed over the lamp flange for further securing the lamp to the vehicle surface. A security flange, as referred to herein, may be any flange installed to prevent the removal of a lamp unit. The security flange may have retaining clips and notches that restricted movement from both the front and the rear of the truck and may be snapped in place or installed using fasteners over a plastic lamp flange.

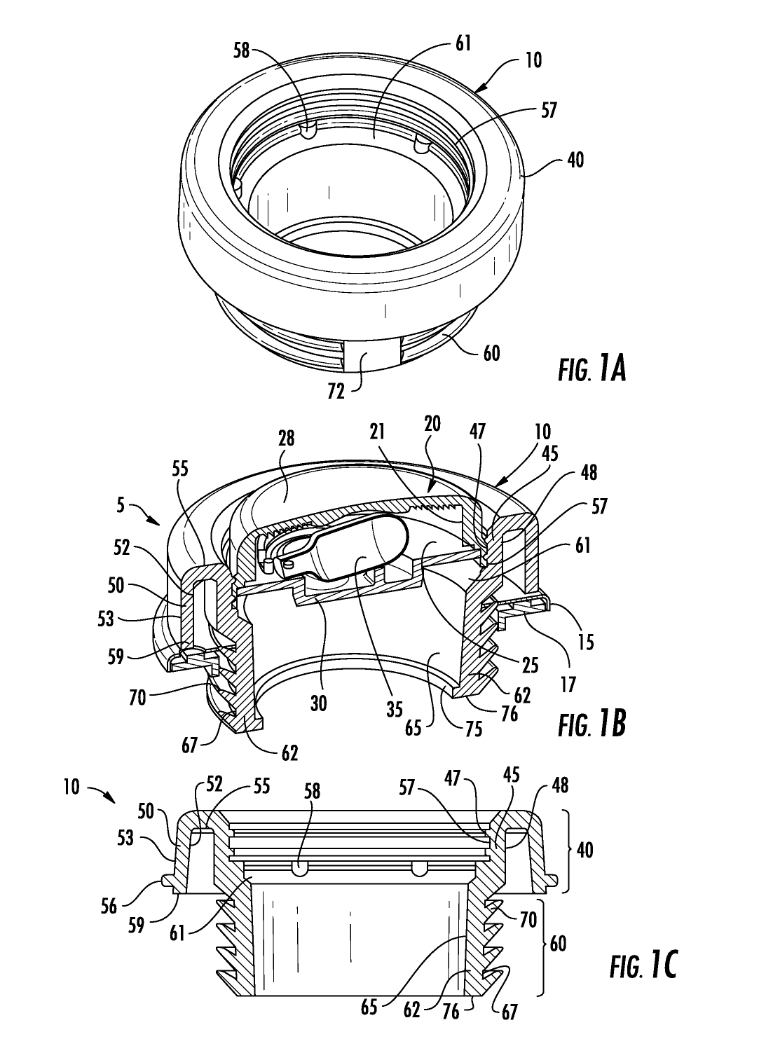

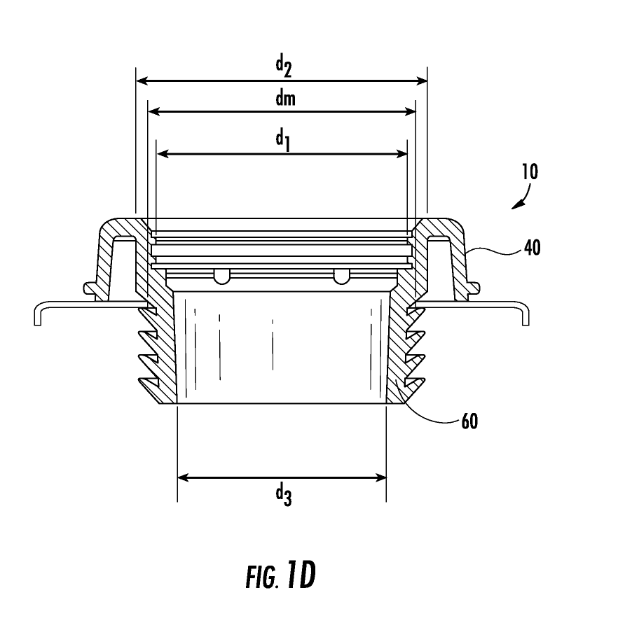

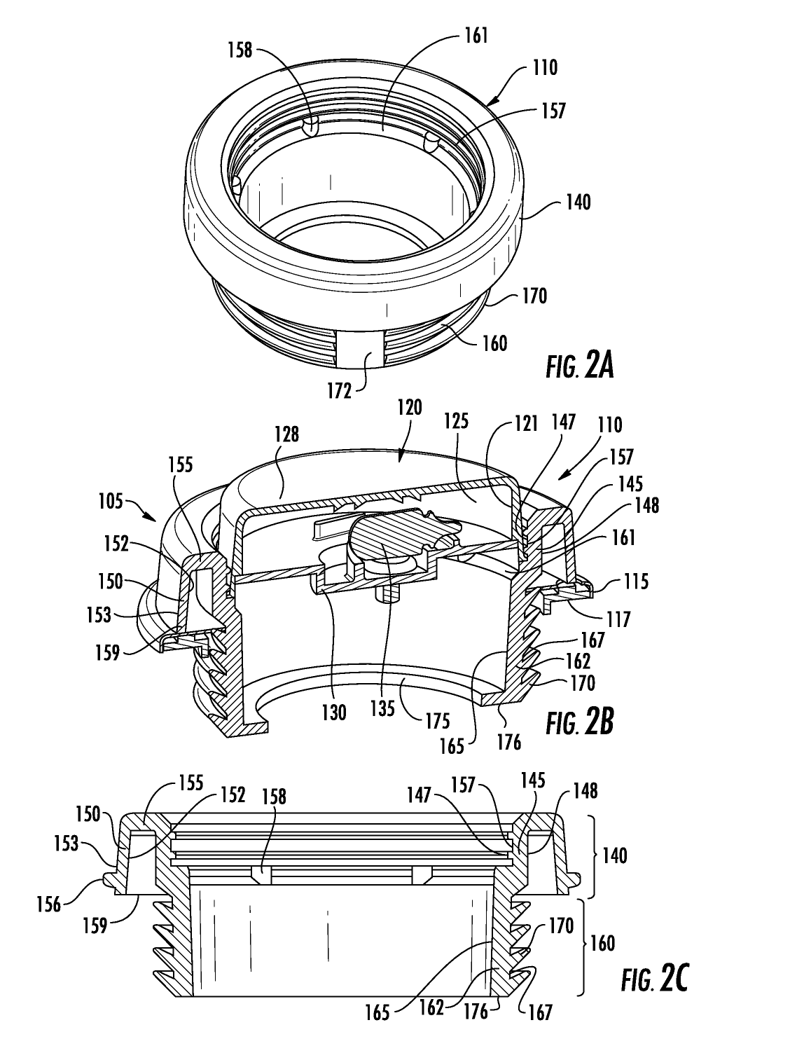

FIGS. 1A, 1B, and 1C show an embodiment of a replacement lamp assembly 5 having an attachment member 10 and a vehicle lamp 20. FIG. 1D illustrates a cross-sectional view of attachment member 10 showing diameters d1-d3. While the diameters are shown with reference to lamp 20 it is to be understood that the additional embodiments described herein have corresponding diameters. In the embodiment shown, vehicle lamp 20 is a replacement lamp such as a two inch round incandescent 12 volt marker & clearance lamp. FIG. 1A is a top perspective view of one embodiment of attachment member 10 of replacement lamp assembly 5 as shown in FIG. 1B. In particular, replacement lamp assembly 5 is intended to be easily installed by a vehicle operator to allow roadside replacement of faulty vehicle lamps. Attachment member 10 is reusable and allows for temporary replacement of vehicle lamp 20. Attachment member 10 is formed from a plastic material, such as black polyvinyl chloride (PVC) with a Durometer of 70+/−5 Shore A. Attachment member 10 is adapted to attach vehicle lamp 20 to an existing opening in vehicle mounting surface from which a lamp, having a plastic lamp flange 17 and a security flange 15, has been broken out. The security flange 15 and plastic flange 17 are left behind in the vehicle surface leaving jagged edges.

Lamp 20 is defined by a housing 21 collectively including having an interior portion 25 and a lens portion 28 covering a top end of a base 30 and the interior portion 25. Circuitry may be disposed within the interior portion 25 of housing 21 with at least one light source 35 being electrically connected to the circuitry. In the embodiment shown, light source 35 is an incandescent light source. Typically, the lamp that has been broken out that requires replacement is a flanged LED lamp with an additional security flange, but may also be an incandescent lamp. Further, the replacement lamp is shown as an incandescent lamp, but may in some embodiments be an LED lamp.

Attachment member 10 includes an upper lamp retaining section 40 having a first cylindrical wall 45 with an inner surface 47 and an outer surface 48 having a thickness of about 2-3 mm. A second cylindrical wall 50 with an inner surface 52 and an outer surface 53 also having a thickness of about 2-3 mm is spaced apart from the first cylindrical wall by about 5-15 mm and connected thereto by an upper edge 55. In the embodiment shown, the overall height of attachment member is about 36 mm with lamp retaining section 40 being about 16 mm in height. A rim 56 may also be formed at a lower end 59 of second cylindrical wall 50. Lower end 59 abuts security flange 15 as shown in FIG. 1B. Inner surface 47 of first cylindrical wall 45 defines an opening having a first diameter d₁, which may be about 49 mm. Outer surface 48 defines a cylinder having a second diameter d₂ that is typically greater than the mounting opening diameter dₘ, i.e. the diameter of the opening in the flange or vehicle surface into which the replacement lamp is installed. In the embodiment shown, the second diameter d₂ of cylinder defined by outer surface 48 is about 56 mm. Inner surface 47 also includes grooves 57 formed therein for engaging and securing lamp housing 21. In the embodiment shown grooves 57 extend about 1.5 mm into inner surface 47. A plurality of protuberances 58 also extend from inner surface 47 below grooves 57 for retaining lamp housing 21. For example, six protuberances 58 may be positioned around the perimeter of inner surface 47 extending outward about 1.9 mm.

Attachment member 10 also includes a mounting section 60 integral with lamp retaining section 40. A sloped wall 61 connects lamp retaining section 40 and mounting section 60. Mounting section 60 includes a third cylindrical wall 62 having an inner surface 65 and an outer surface 67. Inner surface 65 defines an opening having a third diameter d₃ that is smaller than the first diameter d₁ defined by inner surface 47 of first cylindrical wall 45. In the embodiment shown, the third diameter d₃ defined by inner surface 65 is about 41 mm. Outer surface 67 includes a plurality of angled projections 70 extending outward therefrom to a fourth diameter of about 56 mm. Angled projections 70 extend at an angle of about 48 degrees relative to outer surface 67 in a direction towards lamp retaining section 40 for engaging irregular edges of the existing opening or remaining flanges 15 or 17 in the vehicle surface. Although the embodiment shown includes angled projections having a particular angle, it should be understood that other angles may be acceptable and this application is not intended to be limited to the specific values recited herein. There are one or more areas with reduced or without projections, as indicated by reference number 72, to allow for installation of attachment member 10 with the use of reduced force compared to an attachment member with projections 70 extending around the entire outer surface 67. However, in some embodiments projections may 70 may extend around the majority of or the entire outer surface 67. Further, a rim 75 may extend inward from a bottom end 76 of mounting section 60.

FIGS. 2A, 2B, and 2C illustrate a replacement lamp assembly 105 that is a 2½″ reflectorized, incandescent marker & clearance lamp. Although the diameters described herein are only labeled in FIG. 1D, lamp assembly 105 includes corresponding diameters. The specific lamp described is for illustrative purposes only and is not intended to be limiting. Attachment member 110 is adapted to attach vehicle lamp 120 to an existing opening in vehicle mounting surface from which a lamp, having a plastic lamp flange 117 and a security flange 115, has been broken out. When a damaged lamp is broken out, plastic flange 117 and security flange 115 are left behind in the vehicle surface leaving jagged edges. The replacement lamp assembly 105 includes a lamp 120 defined by a housing 121 having an interior portion 125 and a lens portion 128 covering a top end of a base 130 and the interior portion 125. Circuitry may be disposed within the interior portion 125 of housing 121 with at least one light source 135 being electrically connected to the circuitry. In the embodiment shown, light source 135 is an incandescent light source. Typically, the lamp that has been broken out that requires replacement is a flanged LED lamp with an additional security flange, but may also be an incandescent lamp. Further, the replacement lamp is shown as an incandescent lamp, but may in some embodiments be an LED lamp.

Replacement lamp assembly 105 also includes an attachment member 110 including an upper lamp retaining section 140 having a first cylindrical wall 145 with an inner surface 147 having a first diameter d₁ of about 62 mm and an outer surface 148 having a second diameter d₂ of about 70 mm. A second cylindrical wall 150 with an inner surface 152 and an outer surface 153 also having a thickness of about 2-3 mm is spaced apart from the first cylindrical wall by about 10-15 mm and connected thereto by an upper edge 155. In the embodiment shown, the height of attachment member is about 34 mm with the lamp retaining section being about 15 mm in height. A rim 156 may also be formed at a lower end 159 of second cylindrical wall 50. Inner surface 147 of first cylindrical wall 145 defines an aperture having a diameter d₁ of about 62 mm. Outer surface 148 defines a cylinder having a second diameter d₂ that is typically greater than the mounting opening diameter dₘ of the opening in flange 115, 117 or vehicle surface into which the replacement lamp is installed. In the embodiment shown, the second diameter d₂ of cylinder defined by outer surface 148 is about 70 mm. Inner surface 147 also includes grooves 157 formed therein for engaging and securing lamp housing 121. In the embodiment shown, grooves 157 extend about 1.5 mm into inner surface 147. A plurality of protuberances 158 also extend from inner surface 147 below grooves 157 for retaining lamp housing 121. For example, six protuberances 158 may be positioned around the perimeter of inner surface 147 extending outward about 2 mm.

Attachment member 10 also includes a mounting section 160 integral with lamp retaining section 140. A sloped wall 161 or flat shelf-like wall connects lamp retaining section 140 and mounting section 160. Mounting section 160 includes a third cylindrical wall 162 having an inner surface 165 and an outer surface 167. Inner surface 165 defines an opening having a third diameter d₃ that is smaller than the first diameter of the opening formed by inner surface 147 of first cylindrical wall 145. In the embodiment shown, the opening defined by inner surface 165 has a third diameter of about 55 mm. Outer surface 167 includes a plurality of angled projections 170 extending outward therefrom to a fourth diameter of about 70 mm. Angled projections 170 extend at an angle of about 48 degrees relative to outer surface 167 in a direction towards lamp retaining section 140 for engaging the irregular edges of the existing opening in the vehicle surface. Projections are shown to have a height of about 5 mm. Although the embodiment shown includes angled projections having a particular angle, it should be understood that other angles may be acceptable and this application is not intended to be limited to the specific values recited herein. There may one or more areas with reduced or without projections, as indicated by reference number 172, to allow for installation of attachment member 110 with the use of reduced force compared to an attachment member with projections 170 extending around the entire outer surface 167. However, in some embodiments projections may 170 may extend around the majority of or the entire outer surface 167. Further, a rim 175 may extend inward from a bottom end 176 of mounting section 160.

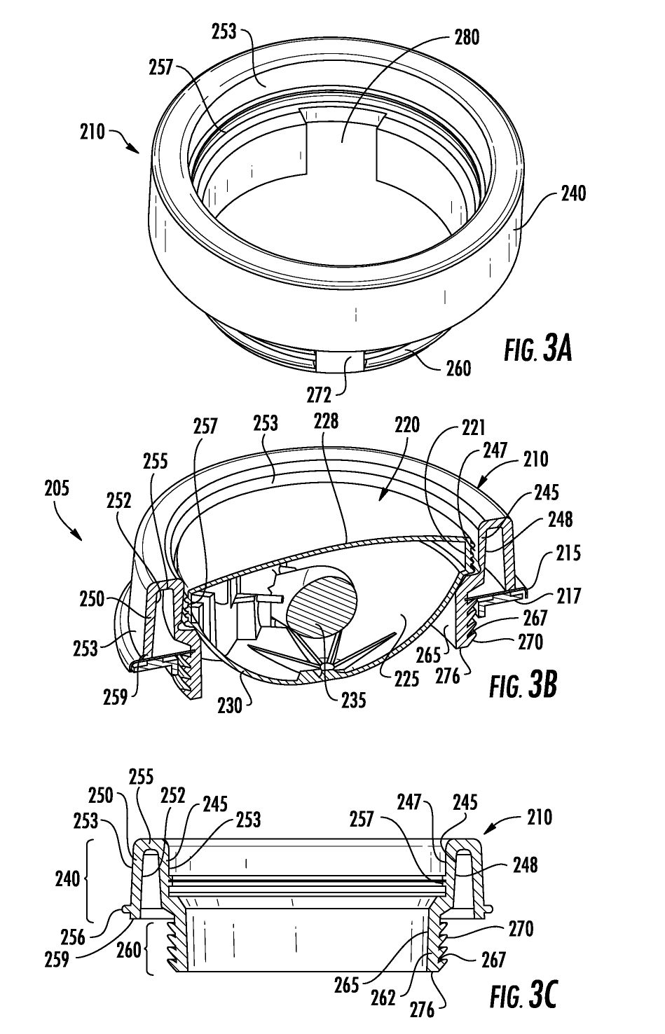

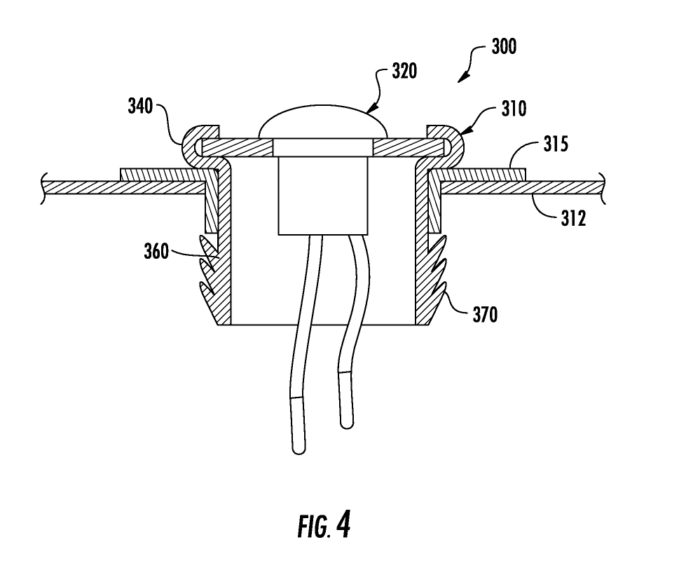

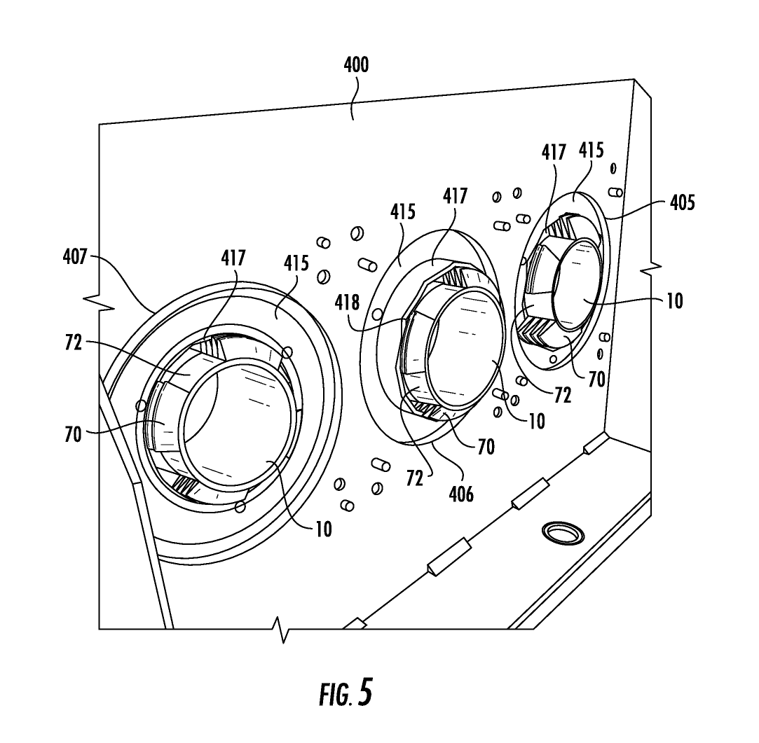

FIGS. 3A, 3B, and 3C illustrate a replacement lamp assembly 205 that is a 4″ round 12vStop/Turn/Tail or Front/Park/Turn housing lamp. The specific lamp described in for illustrative purposes only and is not intended to be limiting. Attachment member 210 is adapted to attach vehicle lamp 220 to an existing opening in vehicle mounting surface from which a lamp having a plastic lamp flange 217 and a security flange 215 has been broken out. The plastic flange 217 and security flange 215 are left behind in the vehicle surface leaving jagged edges. The replacement lamp assembly 205 includes a lamp 220 defined by a housing 221 having an interior portion 225 and a lens portion 228 covering a top end of a base 230 and the interior portion 225. Circuitry may be disposed within the interior portion 225 of housing 221 with at least one light source 235 being electrically connected to the circuitry. In the embodiment shown, light source 235 is an incandescent light source. Typically, the lamp that has been broken out that requires replacement is a flanged LED lamp with an additional security flange, but may also be an incandescent lamp. Further, the replacement lamp is shown as an incandescent lamp, but may in some embodiments be an LED lamp.

Replacement lamp assembly 205 also includes an attachment member 210 including an upper lamp retaining section 240 having a first cylindrical wall 245 with an inner surface 247 having a first diameter d₁ of about 105 mm and an outer surface 248 having second diameter d₂ of about 111 mm. A second cylindrical wall 250 with an inner surface 252 and an outer surface 253 also having a thickness of about 2-3 mm is spaced apart from the first cylindrical wall by about 20-25 mm and connected thereto by an upper edge 255. In the embodiment shown, the height of attachment member 210 is about 49 mm with the lamp retaining section being about 30 mm in height. A rim 256 may also be formed at a lower end 259 of second cylindrical wall 250. Inner surface 247 of first cylindrical wall 245 defines an aperture having a first diameter of about 105 mm. Outer surface 248 defines a cylinder having a second diameter d₂ that is typically greater than the mounting opening diameter dₘ of the opening in flange 115, 117 or vehicle surface into which the replacement lamp is installed. In the embodiment shown, the second diameter of cylinder defined by outer surface 48 is about 111 mm. An upper end of inner surface 247 has a smooth wall 253 and a bottom end of inner surface 247 includes grooves or ridges 257 formed therein for engaging and securing lamp housing 221. In the embodiment shown ridges 257 extend about 2-6 mm outward from inner surface 247.

Attachment member 210 also includes a mounting section 260 integral with lamp retaining section 240. A sloped wall or flat shelf-like wall (not separately labeled) may connect lamp retaining section 240 and mounting section 260. Mounting section 260 includes a third cylindrical wall 262 having an inner surface 265 and an outer surface 267. Inner surface 265 defines an opening having a third diameter d₃ that is smaller than the first diameter d₁ of the opening formed by inner surface 247 of first cylindrical wall 245. In the embodiment shown, the opening defined by inner surface 265 has a third diameter d₃ of about 90 mm. Outer surface 267 includes a plurality of angled projections 270 extending outward therefrom to a fourth diameter of about 107 mm. Angled projections 270 extend at an angle of about 48 degrees relative to outer surface 267 in a direction towards lamp retaining section 240 for engaging the irregular edges of the existing opening in the vehicle surface. Projections are shown to have a height of about 4-5 mm. Although the embodiment shown includes angled projections having a particular angle, it should be understood that other angles may be acceptable and this application is not intended to be limited to the specific values recited herein. In the embodiment shown, there is a cut-out portion 280 to allow for passage of electrical connections. There may also be one or more areas having reduced or no projections, as indicated by reference number 272, to allow for installation of attachment member 210 with the use of reduced force compared to an attachment member with projections 270 extending around the entire outer surface 267. However, in some embodiments projections may 270 may extend around the majority of or the entire outer surface 267. Further, a rim (not shown) may extend inward from a bottom end 276 of mounting section 260.

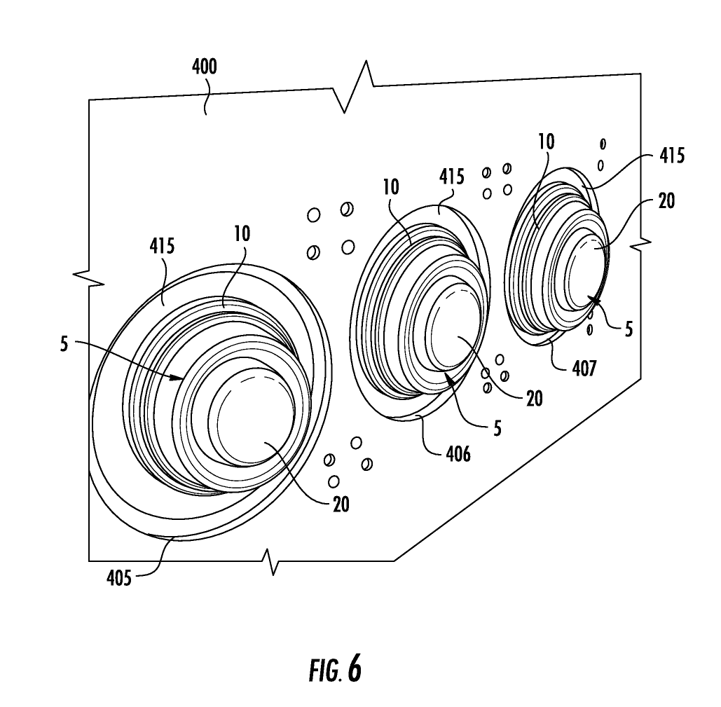

FIG. 4 is an alternate embodiment of a replacement lamp assembly 300 including an attachment member 310 and a lamp 320. Replacement lamp assembly 300 is shown mounted to a vehicle surface 312 having a flange 315 mounted within an opening. Attachment member 310 includes an upper lamp retaining section 340 for engaging and retaining lamp 320. Attachment member 310 also includes a mounting section 360 integral with lamp retaining section 340 having a plurality of angled projections 370 extending outward therefrom in a direction towards lamp retaining section 340 for engaging the irregular edges of the existing opening or flange in the vehicle surface.

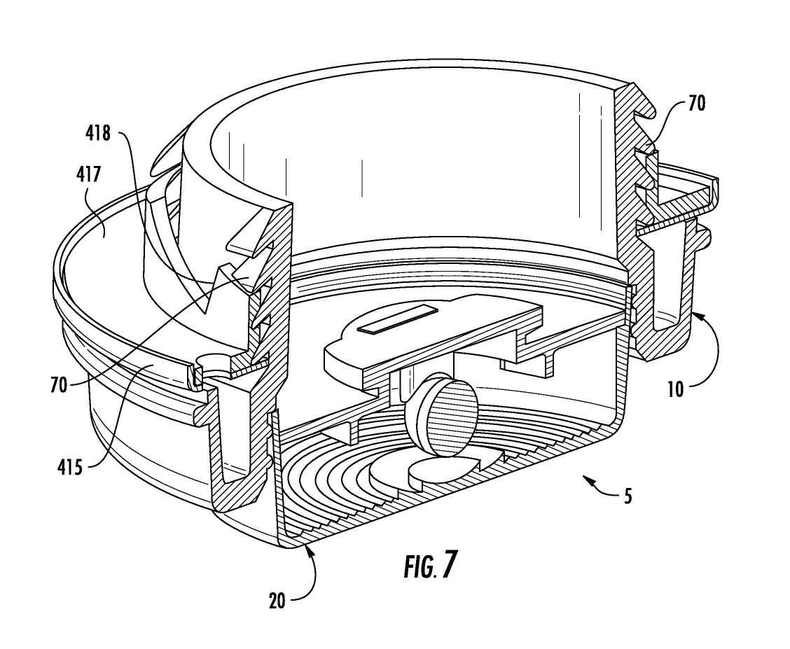

FIG. 5 shows a perspective view of one embodiment of a back side vehicle surface 400 for mounting a replacement lamp assembly 5 and FIG. 6 shows a front side of vehicle surface 400. For the purposes of this description, reference will be made to replacement lamp assembly 5. However, the description is intended to equally apply to each of the variations and embodiments described herein. As illustrated, existing vehicle lamps have been broken out leaving three openings 405, 406, 407 having irregular or jagged edges from blunt force used to remove the lamps. Vehicle surface 400 may be a mounting structure, a wall of a vehicle, or other attachment surface. Prior to installing replacement lamp assembly 5, an existing vehicle lamp, such as a damaged, broken or burnt-out light emitting diode lamp, is broken out of vehicle surface 400 with a hammer or other tool. A center portion of the damaged lamp is broken out, leaving a plastic lamp flange 417 and security flange 415 intact, but with sharp or jagged edges 418, on vehicle surface 400. The broken out lamp is then unplugged from a trailer wire harness and removed from the trailer. The trailer harness is then plugged into replacement lamp. Finally, the replacement lamp is pressed and seated into attachment member 10.

FIG. 7 is a cross-sectional view of replacement lamp assembly mounted to a flange within a vehicle surface (not shown). As shown, plastic flange 417 includes jagged edges 418 that engage projections 70 of attachment member 10 in order to secure replacement lamp assembly 5. Security flange 415 also engages attachment member at the uppermost projection and provides an abutment surface for lower end 59 of second cylindrical wall 50, which further secures lamp assembly 5 within the vehicle surface.

Although, for convenience, the invention has been described primarily with reference to several specific embodiments, it will be apparent to those of ordinary skill in the art that the lamp and the components thereof can be modified without departing from the spirit and scope of the invention as claimed.

1. A replacement lamp assembly for replacing a vehicle lamp that has been broken out leaving at least one cylindrical lamp flange with an opening having a mounting opening diameter, said cylindrical lamp flange being positioned within an opening of a vehicle surface, said replacement lamp assembly comprising:
a vehicle lamp having a housing with a base, a lens and an interior portion with at least one light source positioned therein; and
an attachment member including:
a lamp retaining section having a first cylindrical wall with an inner surface and an outer surface and a second cylindrical wall with an inner surface and an outer surface spaced apart from the first cylindrical wall and connected thereto by an upper edge, wherein a lower end of second cylindrical wall abuts the at least one flange, said inner surface of the first cylindrical wall defining a first aperture having a first diameter, said outer surface of the first cylindrical wall defining a cylinder having a second diameter that is larger than the diameter of the opening of the flange in the vehicle surface, said inner surface including grooves formed therein for engaging and securing the lamp housing; and
a mounting section integral with lamp retaining section having a third cylindrical wall with an inner surface and an outer surface, said inner surface defining an aperture having a third diameter that is smaller than the first and second diameters, said outer surface including a plurality of angled projections extending outward therefrom in a direction towards lamp retaining section for engaging irregular edges of the at least one flange.

2. The replacement lamp assembly of claim 1, wherein a rim extends outward from a lower end of second cylindrical wall.

3. The replacement lamp assembly of claim 1, wherein the inner surface includes grooves formed therein for engaging and securing the vehicle lamp housing.

4. The replacement lamp assembly of claim 3 wherein a plurality of protuberances extend from the inner surface adjacent to the grooves for retaining the vehicle lamp housing.

5. The replacement lamp assembly of claim 1, wherein a sloped wall connects the lamp retaining section and the mounting section.

6. The replacement lamp assembly of claim 1, wherein the angled projections extend at an angle of about 48 degrees relative to the outer surface in a direction towards the lamp retaining section for engaging irregular edges of the existing opening or remaining flanges in the vehicle surface.

7. The replacement lamp assembly of claim 1, wherein there are one or more areas with reduced or without projections to allow for installation of the attachment member.

8. The replacement lamp assembly of claim 1, wherein the projections extend around the entire outer surface.

9. The replacement lamp assembly of claim 1, wherein a rim extends inward from a bottom end of the mounting section.

10. An attachment member for a attaching a replacement lamp assembly in a vehicle surface wherein a vehicle lamp has been broken out leaving at least one cylindrical lamp flange with an opening having a mounting opening diameter, said cylindrical lamp flange being positioned within an opening of a vehicle surface, said attachment member comprising:
an lamp retaining section having a first cylindrical wall with an inner surface and an outer surface and a second cylindrical wall with an inner surface and an outer surface spaced apart from the first cylindrical wall and connected thereto by an upper edge, wherein a lower end of second cylindrical wall abuts the at least one flange, said inner surface of the first cylindrical wall defining a first aperture having a first diameter, said outer surface of the first cylindrical wall defining a cylinder having a second diameter that is larger than the diameter of the opening of the flange in the vehicle surface, said inner surface including grooves formed therein for engaging and securing the lamp housing; and
a mounting section integral with lamp retaining section having a third cylindrical wall with an inner surface and an outer surface, said inner surface defining an aperture having a third diameter that is smaller than the first and second diameters, said outer surface including a plurality of angled projections extending outward therefrom in a direction towards lamp retaining section for engaging irregular edges of the at least one flange.

11. The replacement lamp assembly of claim 10, wherein a rim extends outward from a lower end of second cylindrical wall.

12. The replacement lamp assembly of claim 10, wherein the inner surface includes grooves formed therein for engaging and securing the vehicle lamp housing.

13. The replacement lamp assembly of claim 12, wherein a plurality of protuberances extend from the inner surface adjacent to the grooves for retaining the vehicle lamp housing.

14. The replacement lamp assembly of claim 10, wherein a sloped wall connects the lamp retaining section and the mounting section.

15. The replacement lamp assembly of claim 10, wherein the angled projections extend at an angle of about 48 degrees relative to the outer surface in a direction towards the lamp retaining section for engaging irregular edges of the existing opening or remaining flanges in the vehicle surface.

16. The replacement lamp assembly of claim 10, wherein there are one or more areas with reduced or without projections to allow for installation of the attachment member.

17. The replacement lamp assembly of claim 10, wherein the projections extend around the entire outer surface.

18. The replacement lamp assembly of claim 10, wherein a rim extends inward from a bottom end of the mounting section.
